(19) United States
(12) Patent Application Publication
(10) Pub. No.: US 2021/0217073 A1
(43) Pub. Date: Jul. 15, 2021

(54) Data-Driven Recommendation Engine

(71) Applicant: NCR Corporation, Atlanta, GA (US)

(72) Inventors: Itamar David Laserson, Givat Shmuel (IL); Mor Zimerman Nusem, Even (IL)

(21) Appl. No.: 16/740,015

(22) Filed: Jan. 10, 2020

(51) Int. Cl. G06Q 30/06; G06N 5/04

(52) U.S. Cl. CPC G06Q 30/0631; G06Q 30/0603; G06N 5/04

(57) ABSTRACT

Transaction item codes for transactions are mapped to item vectors within multidimensional space. Each transaction defines a plurality of item vectors for transaction item codes that are mapped within the multidimensional space. Any given item vector's positions within the multidimensional space can have distances calculated to other specific item vectors plotted within the multidimensional space. The distances between the other specific item codes and a given item vector's positions represent probabilities that specific items are likely to be associated with the corresponding item associated with the transaction. Item vector distances below a predefined threshold for a given transaction having a given set of items represent items that are not present in the given transaction but should be recommended to be included with the given transaction. Recommendations are sent in real-time during transactions as items in each of the transactions are identified and as combinations of items change within the transactions.

### BACKGROUND

The usage of product recommendation engines is essential to retailers worldwide. According to various retail studies product recommendation engines provide a 10-25% increase in overall sales. This is even more important in the E-Commerce channel, where customers who click on the product recommendations have a 5.5 times higher conversion rate (online store visits that convert to an actual purchase) than those who do not. Retailers that fail to adopt effective product recommendation methods will lag behind in the rapidly growing E-commerce channel.

The grocery segment, unlike other segments, is characterized by large baskets. The average basket in an E-commerce grocery transaction contains ˜30 items. With so many items in the basket, recommendations should be updated and adjusted as the shopping journey progresses and the basket grows. An effective recommendation engine would therefore, rely on the current combination of the basket to recommend the customer what to buy next. But Current recommendation engines fail to do so.

Current solutions rely on customers' segmentation and shopping history but do not adequately leverage the information that lies in current basket cart content when providing the recommendation. Grocery retailers are therefore, not maximizing the potential in recommendation engines and are losing millions of dollars in lost sales.

### SUMMARY

In various embodiments, methods and a system for data-driven recommendations are presented.

According to an aspect, a method for data-driven recommendations is presented. Specifically, item codes for items of a product catalogue are transformed into item vectors that are plotted into multidimensional space. Transaction item vectors are generated based on transaction items associated with a current transaction. A particular item code for a particular item is identified based on a probability between the particular item code's item vector and at least one of the transaction item vectors. A notification is sent to an interface associated with the current transaction that identifies the particular item code.

### BRIEF DESCRIPTION OF THE DRAWINGS

FIG. 1 is a diagram of a system for data-driven machine-recommendations, according to an example embodiment.

FIG. 2 is a diagram of a method for data-driven machine-recommendations, according to an example embodiment.

FIG. 3 is a diagram of another method data-driven machine-recommendations, according to an example embodiment.

FIG. 4 is a diagram of another system for data-driven machine-recommendations, according to an example embodiment.

### DETAILED DESCRIPTION

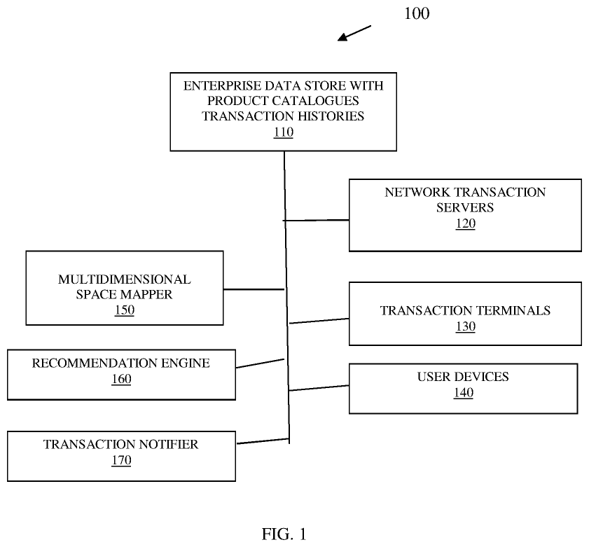

FIG. 1 is a diagram of a system 100 for data-driven machine-recommendations, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of data-driven machine-recommendations presented herein and below.

The system 100 provides a mechanism by which item codes of a product catalogue represents words. A transaction is comprised of the item codes representing the items of that transaction. The mixture or combination of item codes (words) in a given transaction represents a sentence. The item codes are assigned a vector representing a context in which the items that correspond to the item codes were purchased based on analysis of transactions for which the items were purchased. The item vectors represent positions within multidimensional space. Given a transaction having a basket of items, the corresponding item vectors are obtained for that transaction and probabilities that a next item to add to the transaction is produced and sorted in decreasing probabilities. As items are added or removed from a given transaction, the item vectors for the item codes change. At any given point in time, the probabilities between the item vectors and other item codes within the multidimensional space can be calculated. These probabilities are associated with items that are not in the present transaction but are likely to added next based on the context of the item vectors that comprise the present transaction. A configured threshold probability is set, such that when a given probability between item vectors plotted in the multidimensional space for the current transaction is at or below the threshold probability, an assumption is made that the item associated with the given probability should be recommended to be included within the current transaction as an item that a consumer should like to purchase with his/her transaction.

The mechanisms provided herein and below create an enhanced recommendation engine by adding recommendations that are specific to a consumer's basket of items in a given consumer transaction. A recommendation is made to the shopper in real time as to which items to add based on the current content of the basket (the combination of all items that currently exist in the transaction) and the recommendations are adjusted as the basket changes during the shopping journey of the consumer.

In an embodiment, a “Word2Vec” algorithms are deployed. Word2Vec is a group of algorithms used primarily in the field of natural language processing (NLP) for machine translation. Word2vec takes as its input a large corpus of text and produces a vector space, typically of several hundred dimensions, with each unique word in the corpus being assigned a corresponding vector in the space representing that words plotted position within the multidimensional space. Word vectors are positioned in the vector space such that words that share common contexts in the corpus are located in close proximity to one another in the space.

In an embodiment, a Word2Vec model is applied to a given retailer's catalog of products (items) using item codes as the corpus of text-based words. The “sentences” that would be provided as input would be the transactions. Each transaction is defined as a set of items—“words” (item codes). Embedding millions of catalog items into numeric vectors provides significant strength. Mathematical methods can be applied on the vectoral numeric representation of the catalog items to study the affinity between items and extract valuable information that can be monetized. The “Word2Vec” model is therefore leveraged to provide real-time product recommendations. One of the methods provided by “Word2Vec” model is that given a set of words, the model can assess the probability for any other word in the dictionary to appear in the same sentence as the given set of words. In the present modification, “Word2Vec” is adapted to a retailer's product catalog. This means that given a partial basket (a set of items) the model can assess the probability of any other item in the catalog that is likely to be added to the basket. In other words, when applying “Word2Vec” on a large enough set of transactions, the result is a model that can provide product recommendations for any given basket, based on then-existing combination of items that exist in the basket. The resulting recommendations rely purely on data that reflects all customers' shopping patterns known to the retailer as measured and quantified based on millions of past recorded transactions. Consequently, the recommendations are data driven.

The approaches herein do not require manual intervention as commonly needed today with conventional approaches, where promotion experts include presumed logic in their recommendation engines.

The techniques provide a data-driven cart-based up-seller recommender that can be installed as cloud service and consumed by online stores and promotion manager applications. Furthermore, the recommender can be applied alone or, preferably, in conjunction with existing product recommendation engines to enhance the recommendation effectivity and increase the retailer's sales by millions of dollars per year.

As used herein, the terms “consumer,” “customer,” or “shopper” may be used interchangeably and synonymously.

The terms “basket” and “cart” may also be used interchangeably and synonymously herein and below. These terms refer to a collection of products (items) that are part of a transaction for a consumer in which the consumer is planning to buy the items identified in the basket during a checkout. The checkout may be performed online, through a Self-Service Terminal (SST), and/or through a cashier-assisted Point-Of-Sale (POS) terminal.

The system 100 includes, an enterprise data store 110, a network transaction servers 120, a plurality of transaction terminals 130, user-operated devices 140, a multidimensional space mapper 150, a recommendation engine 160, and a transaction notifier 170.

Enterprise data store 110 includes a variety of enterprise data, such as transaction histories for transactions performed with a retailer. Other types of data may be included in enterprise data store 100 as well, such as incentives available to consumers, customer data for known customers, the transaction details for transactions of customers, and other information captured and retained by the enterprise for the store and other stores associated with the enterprise (retailer).

The multidimensional space mapper 150, the recommendation engine 160, and the transaction notifier 170 are executable instructions that reside in a non-transitory computer-readable storage medium. The executable instructions are executed by one or more hardware processors of computing devices. This causes the system 100 to perform the processing discussed herein and below for 150-170.

The network transaction servers 120 are web-based and/or mobile application (app)-based computing devices that process online transactions for consumers. As such, servers 120 include a variety of software and interfaces (transaction services) that permit consumers to shop with a given retailer online through user-devices 140. The transaction services are accessible via an Application Programming Interface (API) permitting real-time transaction details (such as item basket details) to be communicated in real-time during online consumer transactions to recommendation engine 160. The API also permits transaction notifier 170 to relay recommendations for items in a consumer transaction basket to the transaction services.

Transaction terminals 130 comprise a plurality of hardware devices that execute software as services provided throughout an enterprise over one or more networks (wired, wireless, or a combination of wired and wireless). Moreover, terminals 130 include a variety of integrated peripheral devices, such as and by way of example only, card readers (contact based or contactless), touchscreen display, keypad, receipt printer.

Transaction terminals 130 can be self-operated as SSTs (where consumers self-check out to conclude a transaction with a retailer) or can be POS terminals operated by cashiers of an enterprise to provide assisted check outs.

User-operated devices 140 can be any consumer-operated device, such as wearable processing devices, voice-enabled network appliances (Internet-of-Things (loTs) devices), laptops, desktops, tablets, network-based vehicle-integrated devices, and others. Devices 140 utilize retailer-provided interfaces (web-based and/or app-based interfaces) to perform shopping and transaction basket checkouts with transaction services of network servers 120.

Initially, a product catalogue of a retailer comprises a plurality of item codes for products/items of the retailer. Transaction histories for transactions are expressed as a collection of words, each word representing an item code for a specific item associated with a given transaction. For example, a transaction comprising bread, milk, cheese, and eggs are assigned specific retailer item codes in accordance with that retailer's product catalogue as {0001, 2020, 3111, 4003}. Mapper 150 maps the item codes for the transaction into multidimensional space as item vectors based on the unique dimensions identified using a Word2Vec algorithm after deriving the dimensions based on the entire product catalogue. Assuming each point in the multidimensional space is expressed along 3 dimensions, each item code would then be transformed into three coordinates for example bread (item code 0001) may include coordinates as {0.12, 0.23, 0.56}. The collection of coordinates for each item in the transaction is expressed as a mathematical vector through the dimensions of the multidimensional space. For example, example item vectors for the bread, milk, cheese, and eggs transaction may appear as follows:
{0.12, 0.23, 0.56
0.64, 0.25, 0.72
0.42, 0.38, 0.56
0.72, 0.89, 0.04}

The transaction histories for the enterprise within the enterprise data store 110 are transformed into words (item codes) and coordinates that plot to the multidimensional space by mapper 150 based on the contexts for which the items were purchased (obtained from transactions).

Recommendation engine 160 receives real-time item codes for items in a current basket of a consumer through an API associated with transaction services and transaction software of servers 120 and/or terminals 130. Mapper 150 expresses the current basket as item vectors that plots the item codes of the current basket into multidimensional space defining a context through the space (as discussed above). Next, recommendation engine 160 determines the distance between points on the vector to other items plotted within the multidimensional space. A threshold distance is compared against the closest items to the transaction vector and when that distance is at or below the threshold distance, recommendation engine 160 provides the item code or codes for those items to transaction notifier 170. Transaction notifier 170 uses an API to communicate the recommended item codes to the transaction services and/or transaction software of server 120 and/or terminals 130. The items that correspond to the item codes being recommended are communicated in real time by the transaction services and/or transaction software to a consumer associated with the ongoing transaction and its current basket of items or shopping cart. Transaction services and/or transaction software may evaluate retailer-defined rules to determine how the items being recommended are to be presented to the consumer; for example, one or more of the items being recommended may be associated with a retailer-based promotion. Transaction services and/or transaction software may also record or note transactions for which an item upsell recommendation was made and accepted by the consumer. This may assist with determining the success rate of recommendation engine 160.

Mapper 150 determines a unique number of dimensions for a retailer's product catalogue. Each item in the product code is plotted based on its item vector (defined by transaction histories and providing a context with which that item was purchased) within the dimensions. Transactions are then obtained, and each item vector is plotted based on its collection of item codes within the dimensions. As real-time basket or transaction details are obtained for a current transaction of a consumer, mapper 150 plots the new item vectors for the current basket. Recommendation engine 160 determines distances from points on the item vectors to other item vectors plotted within the multidimensional space. When an item vector is within a threshold distance of one or more of the item vectors of the transaction within the multidimensional space, notifier 170 sends the corresponding item code to transaction services and/or transaction software. The consumer is then presented an opportunity to add the corresponding item associated with the recommended item code to the current basket for the consumer transaction. As the consumer removes items or adds items into the current basket, engine 160 uses mapper 150 to adjust the item vectors and its positions within the multidimensional space. This occurs dynamically and in real time, such that recommendation engine 160 is continuously adjusting what items to recommend for upsell based on the current basket of the consumer. As a result, the recommendations are data driven.

In an embodiment, mapper 150, engine 160, notifier 170 are provided through a cloud processing environment that is connected over a network to transaction terminal 130, network servers 120, and enterprise data store 110.

In an embodiment, modules 150-170 are provided as Software-as-a-Service (SaaS) to a given enterprise on a subscription basis.

In an embodiment, the transaction terminals 130 include: a Point-Of-Sale (POS) terminal, a Self-Service Terminal (SST) and/or a kiosk.

In an embodiment, the user devices 140 include: a phone, a tablet, a laptop, IoTs device, and/or a wearable processing device.

In an embodiment, the transaction terminal 130 includes a fuel pump.

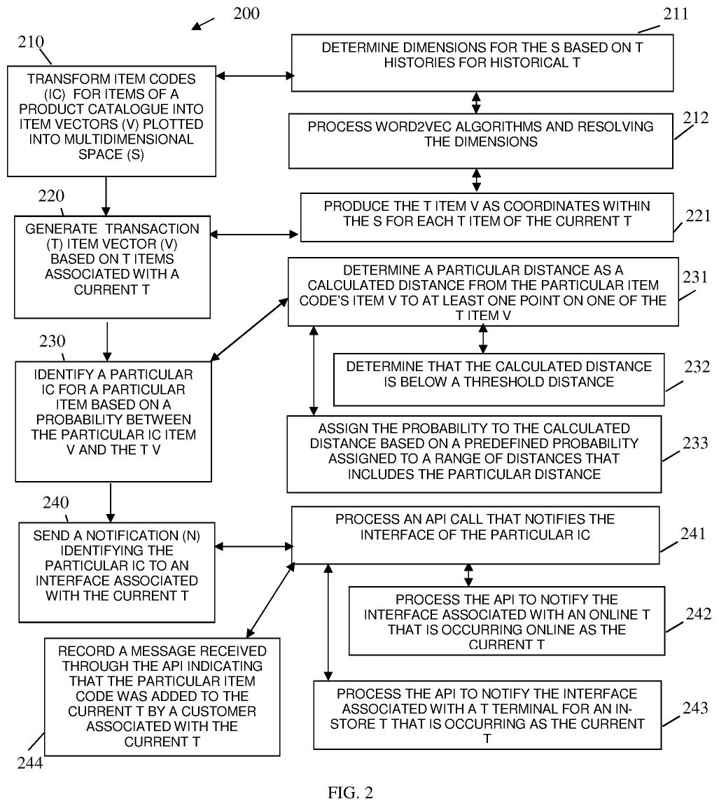

These and other embodiments are now discussed with reference to the FIGS. 2-4.

FIG. 2 is a diagram of a method 200 for data-driven machine-recommendations, according to an example embodiment. The software module(s) that implements the method 200 is referred to as a “recommendation engine.” The recommendation engine is implemented as executable instructions programmed and residing within memory and/or a non-transitory computer-readable (processor-readable) storage medium and executed by one or more processors of a device. The processor(s) of the device that executes the recommendation engine are specifically configured and programmed to process the recommendation engine. The recommendation engine has access to one or more network connections during its processing. The network connections can be wired, wireless, or a combination of wired and wireless.

In an embodiment, the device that executes the recommendation engine is a server. In an embodiment, the server is a cloud processing environment that comprises multiple servers cooperating with one another as a single server. In an embodiment, the server is a Local Area Network (LAN) server.

In an embodiment, the device that executes the recommendation engine is a network-edge device that is local or on an edge of a LAN of a retail store.

In an embodiment, the recommendation engine is all of or some combination of: 150-170.

In an embodiment, the recommendation engine is provided as a SaaS to a plurality of enterprises, each enterprise having a subscription relevant to its customers and its provided transaction and customer data.

At 210, the recommendation engine transforms item codes for items of a product catalogue into item vectors plotted into multidimensional space.

In an embodiment, at 211, the recommendation engine determines dimensions for the multidimensional space based on transaction histories for historical transactions.

In an embodiment of 211 and at 212, the recommendation engine processes one or more Word2Vec algorithms and resolving the dimensions.

At 220, the recommendation engine generates transaction item vectors based on transaction items associated with a current transaction. The transaction item vectors can comprise coordinates for item codes identified within the transaction or basket of transaction items. In an embodiment, the transaction item vectors includes probabilities representing distances between item codes in the current transaction item vectors to other item codes associated with other item vectors.

In an embodiment of 212 and 220, at 221, the recommendation engine produces the transaction item vectors as coordinates within the multidimensional space for each transaction item of the current transaction.

At 230, the recommendation engine identifies particular item code for a particular item based on a probability of an association between the particular item code's item vector and at least one of the transaction item vectors within the multidimensional space.

In an embodiment, at 231, the recommendation engine determines a particular distance as a calculated distance from the particular item code's item vector to at least one point on at least one of the transaction item vectors.

In an embodiment or 231 and at 232, the recommendation engine determines that the calculated distance is below a threshold distance.

In an embodiment of 231 and at 233, the recommendation engine assigns the probability to the calculated distance based on a predefined probability assigned to a range of distances that includes the particular distance.

At 240, the recommendation engine sends a notification identifying the particular item code to an interface associated with the current transaction.

In an embodiment, at 241, the recommendation engine processes an API call that notifies interface of the particular item code.

In an embodiment of 241 and at 242, the recommendation engine processes the API to notify the interface associated with an online transaction that is occurring online as the current transaction.

In an embodiment, of 241 and at 243, the recommendation engine processes the API to notify the interface associated with a transaction terminal for an in-store transaction that is occurring as the current transaction.

In an embodiment, at 244, the recommendation engine records a message received through the API indicating that the particular item code was added to the current transaction by a customer associated with the current transaction.

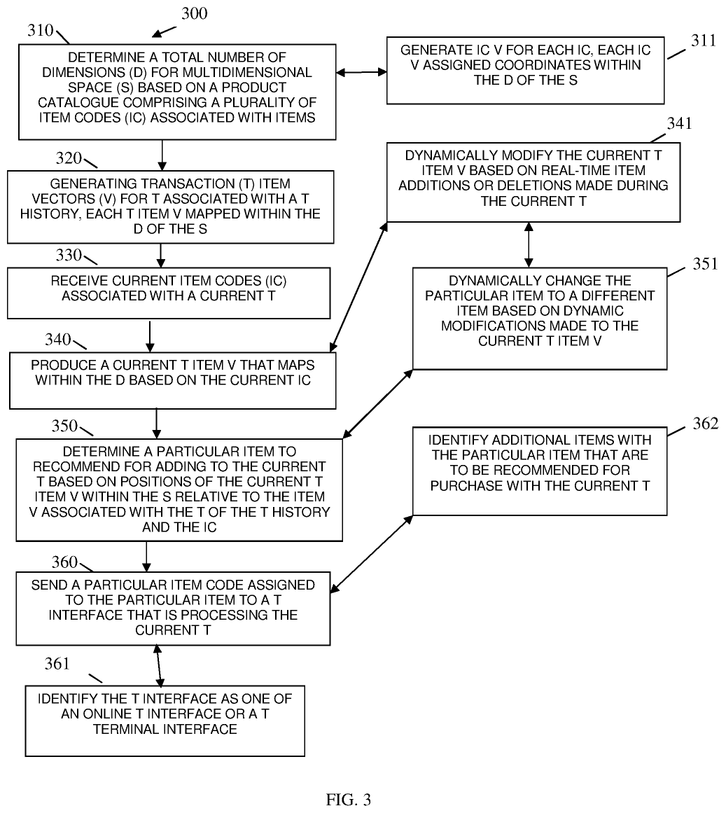

FIG. 3 is a diagram of another method 300 for data-driven machine-recommendations, according to an example embodiment. The software module(s) that implements the method 300 is referred to as a “recommender.” The recommender is implemented as executable instructions programmed and residing within memory and/or a non-transitory computer-readable (processor-readable) storage medium and executed by one or more processors of a device. The processors that execute the recommender are specifically configured and programmed to process the recommender. The recommender has access to one or more network connections during its processing. The network connections can be wired, wireless, or a combination of wired and wireless.

In an embodiment, the device that executes the recommender is a server. In an embodiment, the server is a cloud processing environment that comprises multiple servers cooperating with one another as a single server. In an embodiment, the server is a LAN server that is local to a retail store.

In an embodiment, the device that executes the recommender is a network-edge device that is on the edge of a LAN for a retail store.

In an embodiment, the recommender is all or some combination of: 150-170, and/or the method 200.

The recommender presents another and, in some ways, enhanced processing perspective to that which was described above with the FIG. 2.

At 310, the recommender determines a total number of dimensions for multidimensional space based on a product catalogue comprising a plurality of item codes associated with items.

In an embodiment, at 311, the recommender a particular item code assigned to the particular item to a transaction interface that is processing the current transaction.

At 320, the recommender generates transaction item vectors for transactions associated with a transaction history, each transaction item vector mapped within the dimensions of the multidimensional space.

At 330, the recommender receives current item codes associated with a current transaction.

At 340, the recommender produces current transaction item vectors that map within the dimensions based on the current item codes.

In an embodiment of 311 and 340, at 341, the recommender dynamically modifies the current transaction item vectors based on real-time item additions or deletions made during the current transaction.

At 350, the recommender determines a particular item to recommend for adding to the current transaction based on positions of the current transaction item vectors within the multidimensional space relative to the transaction item vectors associated with the transactions of the transaction history and the item codes.

In an embodiment of 341 and 250, at 351, the recommender dynamically changes the particular item to a different item based on dynamic modifications made to the current transaction item vectors.

At 360, the recommender sends a particular item code assigned to the particular item to a transaction interface that is processing the current transaction.

In an embodiment, at 361, the recommender identifies the transaction interface as one or an online transaction interface or a transaction terminal interface.

In an embodiment, at 362, the recommender identifies additional items with the particular item that are to be recommended for purchase with the current transaction.

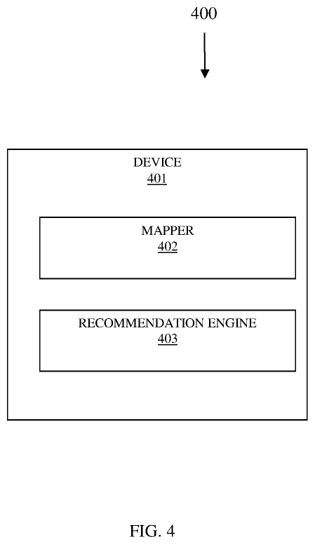

FIG. 4 is a diagram of a system 400 for data-driven machine-recommendations, according to an example embodiment. The system 400 includes a variety of hardware components and software components. The software components of the system 400 are programmed and reside within memory and/or a non-transitory computer-readable medium and execute on one or more processors of the system 400. The system 400 communicates over one or more networks, which can be wired, wireless, or a combination of wired and wireless.

In an embodiment, the system 400 implements, inter alia, the processing described above with the FIGS. 1-3.

The system 400 is the system 100.

The system 400 includes a processing device 401, a mapper 402, and a recommendation engine 403.

In an embodiment, the processing device 401 is a server. In an embodiment, the server is a collection of servers that cooperate as a cloud processing environment.

In an embodiment, the processing device 401 is a network edge device.

The mapper 402 is a set of executable instructions that is executed on one or more hardware processors of the processing device 401 from a non-transitory computer-readable storage medium or memory.

The recommendation engine 403 is also a set of executable instructions that is executed on one more hardware processors of the processing device 401 from a non-transitory computer-readable storage medium or memory.

The mapper 402, when executed by the processor(s) of the device 401, is configured to cause the processor to: 1) determine dimensions of multidimensional space based on item codes of a product catalogue, 2) assign item code coordinates to each item code within the dimensions, 3) generate transaction item vectors for historical transactions, each historical transaction comprising two or more of the item codes, and 4) generate current transaction item vectors based on current item codes assigned to a current transaction.

In an embodiment, the mapper 402 is the mapper 150.

The recommendation engine 403, when executed by the processor(s) of the device 401, is configured to cause the processor to 1) receive the current item codes from a transaction interface that is processing the current transaction, 2) call the mapper with the current item codes to receive the current transaction item vectors, 3) perform a comparison of the current transaction item vectors to the item code coordinates and the transaction item vectors within the multidimensional space, 4) determine at least one additional item code that is not present in the current transaction to recommend based on the comparison, and 5) notify the transaction interface of the at least one additional item code.

In an embodiment, the transaction interface is an online transaction interface or a transaction terminal interface.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
transforming item codes for items of a product catalogue into item vectors plotted into multidimensional space;
generating transaction item vectors based on transaction items associated with a current transaction;
identifying a particular item code for a particular item based on a probability between the particular item code's item vector and a given transaction item's vector and sending a notification identifying the particular item code to an interface associated with the current transaction.

2. The method of claim 1, wherein transforming further includes determining dimensions for the multidimensional space based on transaction histories for historical transactions.

3. The method of claim 2, wherein determining further includes processing Word2Vec algorithms and resolving the dimensions.

4. The method of claim 3, wherein generating further includes producing the transaction item vectors as coordinates within the multidimensional space for each transaction item of the current transaction.

5. The method of claim 1, wherein identifying further includes determining a particular distance as a calculated distance from the particular item code's item vector to at least one point on one of the transaction item vectors of the current transaction.

6. The method of claim 5, wherein determining further includes determining that the calculated distance is below a threshold distance.

7. The method of claim 5, wherein determining further includes assigning the probability to the calculated distance based on a predefined probability assigned to a range of distances that includes the particular distance.

8. The method of claim 1, wherein sending further includes processing an Application Programming Interface (API) call that notifies interface of the particular item code.

9. The method of claim 9, wherein processing further includes processing the API to notify the interface associated with an online transaction that is occurring online as the current transaction.

10. The method of claim 9, wherein processing further includes processing the API to notify the interface associated with a transaction terminal for an in-store transaction that is occurring as the current transaction.

11. The method of claim 9 further comprising, recording a message received through the API indicating that the particular item code was added to the current transaction by a customer associated with the current transaction.

12. A method, comprising:
determining a total number of dimensions for multidimensional space based on a product catalogue comprising a plurality of item codes associated with items;
generating transaction item vectors for transactions associated with a transaction history, each transaction item vector mapped within the dimensions of the multidimensional space;
receiving current item codes associated with a current transaction;
producing current transaction item vectors that maps within the dimensions based on the current item codes; and
determining a particular item to recommend for adding to the current transaction based on positions of the current transaction item vectors within the multidimensional space relative to other item vectors associated with the transactions of the transaction history and the item codes.

13. The method of claim 12 further comprising, sending a particular item code assigned to the particular item to a transaction interface that is processing the current transaction.

14. The method of claim 13, wherein sending further includes identifying the transaction interface as one of an online transaction interface or a transaction terminal interface.

15. The method of claim 12, wherein determining further includes generating item code vectors for each item code, each item code vector assigned coordinates within the dimensions of the multidimensional space.

16. The method of claim 12, wherein producing further includes dynamically modifying the current transaction item vectors based on real-time item additions or deletions made during the current transaction.

17. The method of claim 16, wherein determining further includes dynamically changing the particular item to a different item based on dynamic modifications made to the current transaction item vectors.

18. The method of claim 12, wherein determining further includes identifying additional items with the particular item that are to be recommended for purchase with the current transaction.

19. A system, comprising:
a processing device having at least one processor configured to execute instructions from a non-transitory computer-readable storage medium, the instructions representing a mapper and a recommendation engine;
the mapper is configured when executed by the at least one processor to cause the processor to: determine dimensions of multidimensional space based on item codes of a product catalogue, assign item code coordinates to each item code within the dimensions, generate transaction item vectors for historical transactions, each historical transaction comprising two or more of the item codes, and generate a current transaction item vectors based on current item codes assigned to a current transaction; and
the recommendation manager is configured when executed from the at least one processor to cause the processor to: receive the current item codes from a transaction interface that is processing the current transaction, call the mapper with the current item codes to receive the current transaction item vectors, perform a comparison of the current transaction item vectors to the item code coordinates and the transaction item vectors within the multidimensional space, determine at least one additional item code that is not present in the current transaction to recommend based on the comparison, and notify the transaction interface of the at least one additional item code.

20. The system of claim 19, wherein the transaction interface is an online transaction interface or a transaction terminal interface.
